(19) United States
(12) Patent Application Publication
(10) Pub. No.: US 2014/0279387 A1
(43) Pub. Date: Sep. 18, 2014

(54) AUTOMATED RISK EVALUATION IN SUPPORT OF END USER DECISIONS

(71) Applicant: Fannie Mae, Washington, DC (US)

(72) Inventors: Stacey Shifman, Washington, DC (US); Oleksiy Medinets, Washington, DC (US); Edward Dombroski, Washington, DC (US); Lois Wesly, Washington, DC (US); David Monaco, Washington, DC (US); Matthew Gibbs, Washington, DC (US); Katherine Melnichenko, Washington, DC (US); Kristi Heutnik, Washington, DC (US); James Beattie, Washington, DC (US); Michael Bales, Washington, DC (US); Robert Barclay, Washington, DC (US); Patria S. Kunde, McLean, VA (US); Amanda Woods, Washington, DC (US); Eric Rosenblatt, Derwood, MD (US)

(73) Assignee: Fannie Mae, Washington, DC (US)

(21) Appl. No.: 13/839,320

(22) Filed: Mar. 15, 2013

(51) Int. Cl. G06Q 40/02

(52) U.S. Cl. CPC G06Q 40/025
USPC 705/38

(57) ABSTRACT

A system comprises a device including a memory with an automated collateral fraud and risk detection application installed thereon, wherein the application evaluates risk in an acquisition in support of end user decisions by accessing at least one database to retrieve documentation corresponding to the acquisition and secondary information corresponding to the documentation, the documentation and secondary information each including data fields; compares the documentation data fields with corresponding secondary information data fields to identify acquisition defects; applies risk heuristics on the acquisition defects to generate a probability estimation for each acquisition defect; and outputs a risk evaluation for the acquisition including a confidence metric based on an aggregation of the probability estimations.

### BACKGROUND

Misrepresentation of income, assets, identity, or other key factors on a loan application is difficult to predict because, by definition, borrowers purposefully attempt to hide fraud in order to secure the loan and evade criminal punishment. The anecdotes of janitors reporting extreme salaries, loan officers helping borrowers to write gift letters to hide loans, or pressuring appraisers to raise their estimates of value, are lurid and memorable, but rarely observed. Because these misrepresentations present a significant risk in lending, it may be prudent to search for and identify loan applications with characteristics indicative of misrepresentation so that a reviewer may make a more educated decision regarding pricing determinations, repurchase decisions, and/or transaction validations.

### BRIEF DESCRIPTION OF THE DRAWINGS

FIG. 1 illustrates an exemplary decision support system which includes an automated collateral fraud and risk detection application;

FIG. 2 illustrates an exemplary decision support system in which an automated collateral fraud and risk detection application operates;

FIG. 3 illustrates an exemplary decision support system in which a TAU server operates;

FIG. 4A illustrates an exemplary process flow executed by an automated collateral fraud and risk detection application;

FIGS. 4B-D illustrate exemplary interfaces of an automated collateral fraud and risk detection application;

FIG. 5A illustrates an exemplary process flow executed by an automated collateral fraud and risk detection application; and

FIG. 5B illustrates an exemplary interface of an automated collateral fraud and risk detection application.

### SUMMARY OF THE INVENTION

A system comprises a device including a memory with an automated collateral fraud and risk detection application installed thereon, wherein the application evaluates risk in an acquisition in support of end user decisions by accessing at least one database to retrieve documentation corresponding to the acquisition and secondary information corresponding to the documentation, the documentation and secondary information each including data fields; comparing the documentation data fields with corresponding secondary information data fields to identify acquisition defects; applying risk heuristics on the acquisition defects to generate a probability estimation for each acquisition defect; and outputting a risk evaluation for the acquisition including a confidence metric based on an aggregation of the probability estimations.

### DETAILED DESCRIPTION

In the following description, for purposes of explanation, numerous details are set forth, such as flowcharts and system configurations, to provide an understanding of one or more embodiments. However, it is and will be apparent to one skilled in the art that these specific details are not required to practice the described.

The present invention relates to a decision support system and method for end user computing (EUC) that may provide through generated user interfaces a view of appraisal, loan, and underwriting data. The decision support system may further be a decision support EUC, such as a web based Trusted Appraisal & Underwriting system (TAU), configured to review, test, enhance, and execute a fraud and risk detection model (Model) in support of detecting property transaction defects. Once the Model has detected property transaction defects, the decision support system may present the defects through user interfaces to support end user decisions regarding pricing determinations, repurchase decisions, and/or transaction validations.

The Model, which may also be referred to as an automated collateral fraud and risk detection application, may comprise of a suite of models and methodologies referred to as model heuristics that may generate probability estimations and/or flags for defects within documentation related to a property transaction (e.g., by detecting discrepancies, incentives, and trends within and across the documentation of a mortgage loan delivery package). Defects may include incorrect data within the documentation due to mistake, misrepresentation, and/or fraud. Documentation may include appraisals, underwriting submissions, underwriting approvals, loan documents, credit reports, and the like.

The model heuristics may identify property transaction documentation from a pool of data sources that have a probability of underwriting defects that would lead to an ineligible or mispriced loan. Model heuristics may also estimate the probability of underwriting defects within property transaction documentation and/or score the probability estimations and identified defects based on individual risk characteristics or a total loan view (e.g., a loan resulting from the mortgage loan delivery package).

For example, the Model may evaluate risk in securitized data and delivered loans by comparing credit information to the securitized data and the delivered loans based on risk characteristics to identify defects that may affect pricing determination, repurchase decisions, and/or to transaction validations. In another example, the Model may evaluate risk in sequential underwriting submissions by cross-referencing corresponding data fields of the submissions to identify suspicious data. Thus, as illustrated in both of these examples, the Model may analyze a data set (e.g., documentation) for inconsistencies (e.g., defects) and estimate the probability that the inconsistencies are misrepresentations.

In addition, by utilizing the Model and model heuristics, the decision support system may enable quality assurance reviews of underwriting on a sample loan set flagged with higher defect probabilities. The decision support system may also enable post acquisition discretionary sampling in view of generally waiving lender representation and warrants after a borrower makes 36 payments to identify specific fraud, and patterns of fraud, in support of corrective action. The decision support system further may facilitate development and optimization of the Model to perform early detection of underwriting defects.

FIG. 1 illustrates an exemplary decision support system 100 that includes a computing system 105 having a central processing unit (CPU) 106 and a memory 107 on which are stored an automated collateral fraud and risk detection application 110 comprising an application module 112, an interface module 114 (which generates user interfaces 115) a risk defect module 116, a simulation module 118, and database 120 (which manages data sources 121).

The exemplary decision support system 100 may utilize the computing system 105 and the automated collateral fraud and risk detection application 110 (herein referred to as the application 110) to enable the reviewing, testing, enhancing, and executing of model heuristics 119 in support of detecting inconsistencies in a data set (e.g., the securitized data and the delivered loans, or underwriting submissions). For example, the application 110 of the system 100 may acquire or receive documentation via the application and/or the interface modules 112, 114 for a property transaction. The risk defect module 116 may utilize the model heuristics 119 to evaluate risk in data fields of the documentation in view of other loan and/or sale data (e.g., secondary information) based on risk characteristics. Further, the simulation module 118 may utilize the model heuristics 119 to evaluate risk in sequential underwriting submissions by cross-referencing corresponding data fields of the submissions to identify inconsistencies (e.g., suspicious data). The risk evaluations by the risk defect module 116 and the simulation module 118 may be presented by user interfaces 115 of the interface module 114 for subsequent review in support of end user decisions.

The exemplary computing system 105 may be any computing system and/or device that includes a processor and a memory. In general, computing systems and/or devices may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing systems and/or devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc.

The exemplary decision support system 100 and the exemplary computing system 105 may take many different forms and include multiple and/or alternate components and facilities, e.g., as illustrated in the Figures further described below. While exemplary systems are shown in Figures, the exemplary components illustrated in Figures are not intended to be limiting. Indeed, additional or alternative components and/or implementations may be used.

In general, a processor or a microprocessor (e.g., CPU 106) receives instructions from a memory (e.g., memory 107) and executes these instructions, thereby performing one or more processes, including one or more of the processes described herein. Such instructions and other data may be stored and transmitted using a variety of computer-readable media. The CPU 106 may also include processes comprised from any hardware, software, or combination of hardware or software that carries out instructions of a computer programs by performing logical and arithmetical calculations, such as adding or subtracting two or more numbers, comparing numbers, or jumping to a different part of the instructions. For example, the CPU 106 may be any one of, but not limited to single, dual, triple, or quad core processors (on one single chip), graphics processing units, visual processing units, and virtual processors.

The memory 107 may be, in general, any computer-readable medium (also referred to as a processor-readable medium) that may include any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The application 110 may be software stored in the memory 107 of the computing system 105 that may be executed by the CPU 106 of the computing system 105 to perform one or more of the processes described herein, such as applying the model heuristics 119 stored on the risk defect module 119 and/or the simulation module 118 to a received of accessed data set.

In general, the application 101 may generate probability estimations and/or flags for defects, such as a misrepresentation of borrower income, in documentation for a property transaction. The application 110 may be configured to acquire and/or receive documentation for a property transaction (e.g., data set), which may also be known as loan delivery data, a delivered loan, or an acquisition, as is available in a database 120. An acquisition may include loans and respective data delivered to the exemplary decision support system 100 for storage on the database 120 and processing by the application 110. The application 110 may further synchronize the acquisition with the model heuristics 119 that seek inconsistencies for credit eligibility, income, and the like based on available secondary information.

For example, the application 110 may be configured to process acquisitions of a designated time period on a singular or recurring basis to identify inconsistencies (e.g., generate probability estimations and/or flags) within the acquisitions. The application 110 may further be configured to execute after a lag period (e.g., several months after a loan has been delivered) to account for timing of secondary information availability (e.g., a pending credit report), since the exemplary decision support system 100 may receive or acquire an acquisition without the secondary information being contemporaneously stored on the database 120 or available to the application 110.

A credit report may be an account or statement describing an individual's financial history. In general, an organization, e.g., a credit bureau, compiles financial information for each individual. When that individual applies for a new loan or credit account, lenders use their financial information to determine the individual's credit worthiness. Credit worthiness is a determination of an individual's ability to make, willingness to pay for, and track record for debt payments, as indicated by timely payments to past or current financial obligations.

In addition, although FIG. 1 illustrates modular examples of the application 110, where the modules may be software that when executed by the CPU 106 provides the operations described herein, the application 110 and its modules may also be provided as hardware or firmware, or combinations of software, hardware and/or firmware. Additionally, although one example of the modularization of the application 110 is illustrated and described, it should be understood that the operations thereof may be provided by fewer, greater, differently named, or differently located modules.

The application module 112 may include program code configured to facilitate communication between the modules of the application 110 and hardware/software components external to the application 110. For instance, the application module 112 may be configured to communicate directly with other applications, modules, models, devices, systems, and other sources through both physical and virtual interfaces. That is, the application module 112 may include program code and specifications for routines, data structures, object classes, and variables that receive, package, present, and transfer data through a connection or over a network, as further described below. For example, the application module 112 may be configured to receive input via the user interfaces 115 generated by the interface module 112 and accessing a database 120 based on the received input.

The interface module 114 may include program code for generating and managing user interfaces 115 that control and manipulate the application 110 (e.g., configure model heuristics 119) based on a received input. For instance, the interface module 114 may be configured to generate, present, and provide one or more user interfaces 115 (e.g., in a menu, icon, tabular, map, or grid format) in connection with other modules for presenting information (e.g., data, notifications, instructions, etc.) and receiving inputs (e.g., configuration adjustments, such as inputs altering, updating, or changing the model heuristics 119). For example, the interface module 114 may be configured to generate the user interfaces 115 for user interaction with the application 110, as described below in reference to the below Figures (e.g., FIGS. 4B-D and 5C).

The user interfaces 115 described herein may be provided as software that when executed by the CPU 106 present and receive the information described herein. The user interfaces 115, for example, may include TAU, Upstream system, Quality Assurance System (QAS), Relational Data Warehouse (RDW), ALPHA, Desktop Underwriter (DU), cost basis reporting service (CBRS), Equifax (EFX) Credit Report, Lender Processing Services (LPS) Public Record, and Downstream system interfaces and any similar interface that presents and provides information relative to the application 110. The user interfaces 115 may also be provided as hardware or firmware, or combinations of software, hardware and/or firmware.

The risk defect module 116 may include program code configured to evaluate risk in securitized data and delivered loans by comparing credit information to the securitized data and the delivered loans based on risk characteristics to identify defects that may affect pricing determination, repurchase decisions, and/or to transaction validations.

The risk defect module 116 may be configured to compare secondary information, such as market data, other securitized data, and credit reports, to documentation corresponding to an acquisition. For example, the model heuristics 119 of the risk defect module 116 may compare credit information within the acquisition to a credit report to determine a price difference based on risk based pricing. That is, since good credit may present a lower risk and warrant a more borrower friendly price, the risk defect module 116 may verify that the credit represented in the application is the same as stated by the credit report. This comparison may be utilized by the risk defect module 116 to validate risk characteristics and/or loan delivery data that affect price or eligibility in view of other loan or sale data for a borrower. The model heuristics 119 of the risk defect module 116 may also determine based on credit information comparison whether to have a repurchase altogether or whether the acquisition was appropriate after the fact.

The model heuristics 119 of the risk defect module 116 may in view of these comparisons provide flags, tokens, markers, messages, pop-ups, or the like, which identify the acquisition as a bad transaction and notify an end user of the bad transaction before completion. For instance, because the risk defect module 116 detected that a credit score stated in an acquisition may be incorrect, the risk defect module 116 may automatically message the end user to review this acquisition for pricing adjustments or eligibility. The end user may in turn use the flagged credit score to support decisions regarding pricing determinations, repurchase decisions, and/or transaction validations.

The risk defect module 116 may further be configured to provide a credit report operation, where the risk defect module 116 may acquire and standardize a borrower's credit and tradeline history. The risk defect module 116 may then be configured to analyze (e.g., break down) a borrower's credit history by individual lines of credit and may identify differences in the history that may factor materially into a loan origination decision. Therefore, the risk defect module 116 may be configured to determine whether a specific loan is prudent under the loan terms by a cross-referencing analysis of the loan information (e.g., credit, value of collateral, etc.).

In addition, the risk defect module 116 may be configured to further enhance the comparison between an acquisition and secondary information by applying model heuristics 119 that estimate the probability that the inconsistencies are misrepresentations. As further described below, the risk defect module 116 may correlate variables to data fields of the acquisition and perform a regression to generate for each variable coefficients, which are further utilized by the risk defect module 116 to generate probability estimations (e.g., probability that the inconsistencies are misrepresentations). In turn, the risk defect module 116 may be configured to output a risk evaluation for the data fields of acquisition including a confidence metric based on the probability estimations and provide the risk evaluation (via user interfaces 115 generated by the interface module 114) to a reviewer, who in turn may review and implement some form of recourse.

A confidence metric may indicate that the relative defect risk is high or low on any scale as configured via the application 110a (e.g., a scale of 1 to 5, with 5 being an indicator of the highest confidence that a defect exists). Heuristic level confidence metrics are aggregated into risk variable level metrics, which are further aggregated to property transaction level confidence metrics.

The simulation module 118 may include program code configured to evaluate risk in sequential underwriting submissions by cross-referencing corresponding data fields of the submissions to identify inconsistencies (e.g., suspicious data). For example, the simulation module 118 may be configured to compare multiple automated sequential underwriting submissions received through a user interface 115 generated by the interface module 114 to determine if the underwriting submissions being improperly manipulated (e.g., gaming an automated underwriting system). Gaming an automated underwriting system may include the situation where multiple sequential underwriting submissions that pertain to the same transaction contain disparate information that affects the price and/or eligibility of the property transaction.

The simulation module 118 may be configured to observe or detect data changes (e.g., disparate information between underwriting submissions) in the automated underwriting systems. Examples of data changes may include incrementally changing or varying information within underwriting submissions in regards to occupancy status (owner occupied vs. investment property), income, credit score with respect to a borrower's income, residency, debts, assets, etc. The simulation module 118 may be configured to provide flags, tokens, markers, messages, pop-ups, or the like that identify the property transaction related to the multiple sequential underwriting submissions as characteristic of a higher risk than may be stated by the underwriting submissions.

For example, manipulating the automated underwriting system may include when a loan officer attempts to trick the automated underwriting system by submitting a first underwriting request, which is rejected by the automated underwriting system, and then manipulating each subsequent request until the automated underwriting system generates an approval. Also, for example, manipulating the automated underwriting system may include when a loan officer attempts to trick the automated underwriting system by receiving an approved request that renders a first loan, and then altering the approved request until the automated underwriting system approves a more favorable subsequent loan for the borrower. In either situation, the simulation module 118 may utilize model heuristics 119 to detect multiple ‘failing’ requests/submissions or multiple approved loan values and flag the property transaction for manual risk evaluation (e.g., messaging an end user to review of the property transaction and related collateral).

The simulation module 118 may also be configured to evaluate risk by generating a particular model heuristic 119 to assess data credibility in underwriting submissions. An example of a particular model heuristic 119 may be a significance test that detects which data is continuously being manipulated by end users based on an automated underwriting system feedback. For instance, with the ability to manipulate data through the automated underwriting system, a loan officer may game the automated underwriting system to identify which factors are significant to a relative loan approval (e.g., which factors should be manipulated to receive a loan approval) and then only manipulate those factors in the future. Based on this situation, the simulation module 118 may be configured to apply the significance test to automatically scrutinize underwriting submissions to enhance the detection of manipulating significant factors.

In addition, the simulation module 118 may be configured to further enhance the identification of inconsistent information indicative of underwriting manipulation by flagging a property transaction comprising disparate information between sequential underwriting submissions and identifying a risk level based on the significance of the data manipulated. The simulation module 118 may be configured to then present via the user interfaces 115 of the interface module 114 the flags and risk level as a risk evaluation for end user review.

The model heuristics 119 may be program code configured to generate probability estimations, flags, messages, and the like, including calculating a confidence metric based on an aggregation of the defect probability estimations for transaction documentation. The model heuristics 119 employed by the risk detection module 116 and/or the simulation module 116 may detect inconsistencies through a segmented approach that improves the identification of misrepresentation, enables stratified sampling of specific defects, and enables communication to a reviewing underwriter of a suspicious variable, a condition, and the like.

In general, the model heuristics 119 may be configured to identify misrepresentation via rule based heuristics that compares data provided by a lender to other data for verification. For example, when compared, a borrower's mailing address in a lagged credit report may be different from an owner-occupied mortgage's property address (as further illustrated in FIG. 4D).

Further, the model heuristics 119 may also be configured to employ narrow definitions of the dependent variable, such as, income misrepresentation or asset misrepresentation. For example, the model heuristics 119 may be configured to estimate income via an empirical heuristic that identifies the variables that are highly correlated with income misrepresentation. The empirical heuristic may be a binomial logistic regression (Equation 1) where the dependent variable (income misrepresentation) is either ‘yes’ or ‘no’.

$$logit ( π ) ≡ log ( \frac{π}{1 - π} ) = α + {β}^{′} x \qquad Equation 1$$

The empirical heuristic may be enhanced through the application 110 by quantifying explicitly in a separate set of heuristics a loan officer's or underwriting agent's historical correlation to performance and defects and considering a higher joint likelihood of defects if both the agent and income misrepresentation are considered high risk.

The database 120 may include any type of data or file system (e.g., data sources 121) that operates to support the application 110. For instance, data sources 121 may include documentation (e.g., appraisals, underwriting submissions, underwriting approvals, loan documents, credit reports, and the like) relating to a property transaction, a data sets (e.g., the securitized data and the delivered loans, or underwriting submissions), other loan and/or sale data (e.g., secondary information), acquisitions, and/or any other data relating to or including borrower information, property address information, reported address information, credit report information (e.g., a set of credit reports), loan information, status information, etc. The data, heuristics, and variables of the exemplary decision support system 100 that support and enable the above described utility may be stored locally, externally, separate, or any combination thereof, as further described below.

In general, databases, data repositories or other data stores, such as database 120, described herein may include various kinds of mechanisms for storing, providing, accessing, and retrieving various kinds of data, including a hierarchical database, a set of files in a file system, an application database in a proprietary format, a relational database management system (RDBMS), etc. Each such data store may generally be included within a computing system (e.g., computing system 105) employing a computer operating system such as one of those mentioned above, and are accessed via a network or connection in any one or more of a variety of manners. A file system (e.g., data sources 121) may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In addition, as indicated in FIG. 1, database 120 includes data sources 121 and may be provided as software stored on the memory 107 of computing system 105. Database 120 may also be provided as hardware or firmware, or combinations of software, hardware and/or firmware. For example, as indicated in FIG. 2, databases 120a-b may be a computing system as described above, including a CPU 106 and memory 107, that is separate from a computing systems 105a-b.

Further, in some examples, computing system 105 elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In addition, the computing system 105 may take many different forms and include multiple and/or alternate components and facilities, e.g., as in the Figures further described below. While an exemplary computing system 105 is shown in FIG. 1, the exemplary components illustrated in the Figures are not intended to be limiting. Indeed, additional or alternative components and/or implementations may be used.

FIG. 2 illustrates an exemplary decision support system 200 including multiple computing systems. For instance, the exemplary decision support system 200 may include computing systems 105a-b, where each includes a CPU 106 and a memory 107 with an application 110 installed thereon, and databases 120a-b, where each includes a CPU 106 and a memory 107 on which data sources 121 are managed and stored. Note that the same or equivalent elements as those of the FIG. 1 described above are denoted with similar reference numerals, and will not be described in detail with regard to FIG. 2.

In FIG. 2, the applications 110a-b of the computing systems 105a-b illustrate examples of different modulations, such as the computing system 105a may include a host application 110a modulated to supply the model heuristics 119 of the risk defect module 116 and the simulation module 118 to a client application 110b of the computing system 105b. The client application 110b, in turn, may supply input to the host application 110a received via the user interfaces 115 generated by the interface module 114. The exemplary decision support system 200 may further include a network 230 through which the computing systems 105a-b communicate via physical connections 231 that may provide the infrastructure to establish virtual connections 235, such that the model heuristics 119 and the input may be transferred.

In operation, the exemplary decision support system 200 may acquire or receive documentation as input via the user interfaces 115 of the interface modules 114 of the client application 110b. The computing system 105b may transfer via the virtual connection 235 through the network 203 the documentation to the host application 110a for processing. The host application 110a may utilize its modules and the model heuristics 119 to evaluate risk in data of the documentation in view of other loan and/or sale data (e.g. data sources 121) located on the database 120a by establishing the virtual connection 235. The host application 110a may further transfer the risk evaluation to the client application 110b for subsequent review through the user interfaces 115 of the interface module 114 in support of end user decisions.

The network 230 may be a collection of computers and other hardware to provide infrastructure to establish virtual connections and carry communications. For instance, the network 230 may be an infrastructure that generally includes edge, distribution, and core devices and provides a path for the exchange of information between different devices and systems (e.g., between the computer systems 105a-b). Further, the network 230 may be any conventional networking technology, and may, in general, be any packet network (e.g., any of a cellular network, global area network, wireless local area networks, wide area networks, local area networks, or combinations thereof, but may not be limited thereto) that provides the protocol infrastructure to carry communications between the computer systems 105a-b and the host and the client applications 110a-b.

Physical connections 231 may be wired or wireless connections between two endpoints (devices or systems) that carry electrical signals that facilitate virtual connections (e.g., transmission media including coaxial cables, copper wire, fiber optics, and the like). For instance, the physical connection 231a may be a wired connection between computer systems 105a and database 120a, and the other physical connections 231 may be wired or wireless connections between computer systems 105a-b, database 120b, and routers on the edge of the network 230. Further, the physical connections 231 may be comprised of computers and other hardware that respectively connects endpoints as described.

Virtual connections 235 are comprised of the protocol infrastructure that enables communication to and from applications 110 and databases 120.

FIG. 3 illustrates an exemplary decision support system 300 including multiple computing systems, as described above, where a TAU server 105a operates in combination with the host application 110a to perform the operations described herein. Note that the same or equivalent elements as those of the above Figures are denoted with similar reference numerals, and will not be described in detail with regard to FIG. 3.

The exemplary decision support system 300 may include computing systems such as the TAU server 105a, computing systems 105b, TAU Database 120a, an RDW 120b, a DU RDW 120b, and a QAS 120b, which connect via respective direct physical connections 231 or remote physical connections 231 through the network 230. Similar to exemplary decision support system 200, TAU server 105a may provide host services to other computing systems 105b while accessing databases 120a-b The TAU server 105a may further bridge the data sources 121 on the databases 120a-b by utilizing the host application 110a.

The TAU server 105a may provide defect likelihoods at a risk variable level to an end user through a single use portal (e.g., user interface 115). A single use portal may be configured to enable end users at one of the computing systems 105b to view the data sources 121 and the results of the model heuristics 119, as well as reviewer findings. The end user may also review the efficacy of the model heuristics 119 in defect identification and hypothesize improvements to the model heuristics 119. Further, the single use portal may provide a simulator for pricing and underwriting eligibility that enables the end user to test if the defect would have produced a significant change.

For example, an end user at one of the computing systems 105b may utilize the single use portal to query the TAU server 105a for an acquisition, which in turn accesses the databases 120a-b storing documentation relative to the acquisition. The end user may also utilize the single use portal to search for all acquisitions that meet an input criteria on a range of variable confidence metrics or risk characteristics (e.g., utilizing a dropdown search menus of a single use portal generated by a local interface module to input value selections). The end user at one of the computing systems 105b may also utilize a dropdown search menus of a DU simulator interface generated by a local interface module to input value selections for different simulator values. Additional search filters that may be utilized via the single use portal include confidence metrics, risk characteristics, performance metrics, loan number, searches based on related loan entities.

The TAU server 105a may further present, via the single use portal, data for manual review based on other criteria including random sampling, discretionary higher risk transactions, early delinquencies, and defaults. For example, the TAU server 105a may display defect confidence metrics and messages, data (including associated variables) that feed risk metrics, loan summaries, loan data, agent data, DU data, credit reports, and the like.

The TAU database 120a may store local data sources 121 relating to QAS, RDW, DU, ULDD, ALPHA, CBRS, EFX Credit Report, LPS Public Record, and the like. Further, these data sources 121 may also be stored on their own separate databases, as represented by RDW 120b, DU RDW 120b, and QAS 120b.

In operation, the TAU database 120a may provide via data sources 121 borrower identification data and other data, such as employer name and documentation, along with QAS to the TAU server 105a. By providing the data sources 121, the TAU database 120a enables the TAU server 105a to present the data sources 121 along with risk evaluation for review to end users via the single use portal. In turn, the TAU server 105a may also receive manual review findings from the end users as a population input, including categorizations of defect type and severity of inconsistencies, which are stored with the Quality Assurance System (QAS) data sources 121 on the TAU database 120a or QAS 120b.

Further, the TAU server 105a may enable end user review of the population input parsed by a designated time period (e.g., a sample population), where the time period may span any combination of days, months, and years, in support of improving estimations of the eligibility, underwriting, and review standards for designated time periods. Thus, the TAU server 105a may also be configured to differentiate the population input into a sample population for a housing recession time period and a sample population for a housing boom time period and apply model heuristics 119 particular to each respective sample population. For instance, for the housing recession time period population, the TAU server 105a may further apply model heuristics 119 to the sample population that account for the tightening of underwriting standards, an above average defect rate, and a volume increase in defects.

The TAU server 105a may also be configured to account for designated time periods that produce too few defects for a sample population to estimate risk with confidence. In this case, the TAU server 105a may oversample transactions/loans in the sample population with higher credit risk and higher defect rates to provide more defects and higher statistical confidence for the estimations of the model heuristics 119. Oversampling by the TAU server 105a may permit the misrepresentation estimations to be biased upwards because the delinquency and default population inherently has a self-selection bias for loan defects (e.g., due to underwriting defects being associated with worse loan performance). The TAU server 105a may further ignore the review bias or adjust a predicted probability to observed defect rates.

The TAU server 105a may also exclude from a sample population transactions/loans that shared recourse with a lender and were subsequently repurchased from the estimation population because the repurchase would be contractually required based on loan performance rather than on a discovered defect, which has a censoring affect on the observed dependent variable of those loans. The TAU server 105a may also exclude from a sample population transactions/loans where the borrower paid a higher rate in return for not documenting their income (e.g., low-doc and/or no income no asset (NINA) loans) because these loans may no longer eligible for delivery and/or may not be legal, as proving an income defect on these loans has a different standard for review underwriters.

Tables 1 and 2 are examples of development data for two sample populations, as generated by the TAU server 105a utilizing the host application 110a to bridge the data sources 121 on the databases 120a-b:

TABLE 1
Development Data For Period AB

| Designated Time Period | dd/mm/AAAA-dd/mm/BBBB |
|---|---|
| Exclusions | Low-doc loans; NINA loans |
| # of Loans | 265,143 |
| # of Defects | 11,448 |
| Defect Rate | 4.3% |

TABLE 2
Development Data For Period XY

| Designated Time Period | dd/mm/XXXX-dd/mm/YYYY |
|---|---|
| Exclusions | NINA loans |
| # of Loans | 293,303 |
| # of Defects | 8,213 |
| Defect Rate | 2.8% |

Note that although the time periods are not specified in Tables 1 and 2, both tables represent distinct time periods. Accordingly, the TAU server 105a found a defect rate of 4.3% for the development data of a Period AB. The TAU server 105a found a defect rate of 2.8% for the development data of a Period XY. To discover these defect rates for these time periods, the TAU server 105a may analyze the sample population for inconsistencies (e.g., defects) and estimate the probability that the inconsistencies are misrepresentations by confirming data accuracy and eligibility via the risk detection module 116 and the simulation module 118.

FIG. 4A illustrates a process flow 400 utilized by the TAU server 105a (e.g., a host automated collateral fraud and risk detection application 110a) to evaluate risk in a property transaction in support of end user decisions. Further, FIG. 4A illustrates an example analyzing risk variables of a delivered loan by the model heuristics 119 to produce a confidence metric that conveys the relative defect risk of the delivered loan. FIGS. 4B-D illustrate exemplary interfaces that the end user may encounter when interacting with the TAU server 105a through the computing systems 105b.

The process flow 400 may start upon the TAU server 105a receiving 410, e.g., from an end user utilizing a single use portal at one of the computing systems 105b, a query regarding a property transaction. For example, the query may identify an acquisition and indicate that the end user wishes to estimate the risk of income and asset defects within the acquisition. FIG. 4B illustrates an exemplary search screen 410a of the single use portal including dropdown search menus. Each dropdown search menu may configure a unique search that may trigger subsequent access to data sources 121. The exemplary search screen 410a may be generated by a local interface module of one of the computing systems 105b. The exemplary search screen 410a may group the dropdown menus into categories, such as “TAU findings,” “Score,” “Loan Data,” and “Performance Metrics,” to ease the input value selections into the dropdown menus. The exemplary search screen 410a may also enable direct entry of a loan number into a box 412, such that a particular acquisition may be directly accessed.

In response to the query, the TAU server 105a continues by accessing 420 at least one database (e.g., database 120a-b) to retrieve documentation and secondary information corresponding to the property transaction identified in the search query (e.g., the loan number entered into box 412). In the case of a receiving a loan number, the TAU server 105a may access databases 120a-b to retrieve a delivered loan particular to the entered loan number and secondary information related to the delivered loan stored within the data sources 121.

Next, the TAU server 105a compares 430 the documentation data fields with corresponding secondary information data fields to identify acquisition defects (e.g., inconsistencies within the property transaction). For example, when the data of the delivered loan is compared with the data of the credit report, the credit score of the borrower represented in the delivered loan is compared to the credit score listed within the credit report. If these two scores do not equate, the credit score field of the delivered data is identified as defective (e.g., a property transaction defect).

Similarly, income and assets of the borrower represented in the delivered loan may also be compared to secondary information. FIG. 4C illustrates an excerpt of an exemplary loan summary screen 440a of the single use portal. The excerpt illustrates the interaction between the confidence metric column 442, the identified income inconsistency 444, and the risk evaluation 446. As seen in FIG. 4C, based on a comparison between a self-employed income of $12,057 and $11,559, the identified income inconsistency 444 is a $498 difference. Note that the model heuristics 119 tag the income category with a message “Possible income misrepresentation.”

The TAU server 105a continues by estimating 440 coefficients for variables correlated to the property transaction defects. For example, when an income or an asset is found to be inconsistent via the comparison 430, the TAU server 105a may apply the model heuristics 119 to estimate the probability that the inconsistencies are misrepresentations. As seen in the confidence metric column 442 of FIG. 4C, the model heuristic applied a confidence metric of 3 out of 5 to $498 income consistency 444.

To generate this confidence metric, the model heuristics 119 may correlate independent variables (e.g., predictive variables and standard credit risk variables) to identified inconsistencies. Once correlated, a regression is performed on the independent variables to generate coefficients, which are utilized to produce heuristic level confidence metrics for each inconsistency. Note that although comparing 430 and estimating 440 are itemized separately within the figure, these operations may be performed simultaneously.

Examples of model heuristics coefficients may include statistical significance, business significance, reasonableness, and substitutes.

Statistical significance may be a coefficient that should have at least a 95% confidence. An exception is made if the variable is one of many categories in the same business measure, and a single category produces a coefficient near zero. In that case the selection is based on the reasonableness of the relative coefficient from a business context, and the size of the variable's standard error.

Business significance may be a coefficient based on when very large estimation samples create statistical significance on coefficients that are so small that they make little difference from a business context, and are merely a distraction operationally. In general, coefficients of at least +/−0.15 are desired in order to be included, though this does not apply to variables that are part of a categorical range on an underlying continuous field.

Reasonableness may be a coefficient that should have a sign that is not counterintuitive. Nor should variables be included that have no plausible explanation and are likely spurious data mining (e.g. yellow houses have more fraud). If a significant but counterintuitive result is observed, an explanation is sought from subject matter experts in the business operation.

Substitutes may be coefficients that are highly correlated, particularly if they are different metrics of similar business concept. In such cases, experiments of model specification are made with the coefficients input separately, and together. The version with the best model heuristic 119 fit and reasonableness may be selected by the host application 110a. The inclusion of multiple highly correlated variables often leads to counterintuitive and offsetting coefficients, as was seen in the various possible expressions of ‘not DU’, and requires eliminating largely redundant variables.

Regarding income defects, as indicated above, the model heuristics 119 may be utilized by the TAU server 105a to estimate income misrepresentation risks by setting parameters and utilize independent variables to test the probability of dependent variables.

Examples of independent variables for income misrepresentation may include income change from prior mortgage, streamlined refinance, verbal verification of employment, DU income change, employer size, employer type, combined loan-to-value (LTV), minimum FICO, debt-to-income (DTI), occupancy, loan amount, 15-year fixed rate, one borrower, 2-4 unit, DU control, and the like. FIG. 4D illustrates an exemplary loan data screen 440b of the single use portal showing an inconsistency in occupancy across three acquisitions. That is, the exemplary loan data screen 440b further illustrates a borrower history table linking the borrowers “30810184” and “19243769” over time via three loans “1706899751,” “1716253630,” and “1716551548,” which were consecutively originated in March, April, and May. The exemplary loan data screen 440b further illustrates that each borrower represented an occupancy of “Primary,” as shown in block 448, for each of the three loans. As noted in block 449, the address of the property is different for “1716253630,” and thus the model heuristic 119 has identified a possible occupancy misrepresentation by these borrowers.

An ‘income change from prior mortgage’ independent variable may be when the subject mortgage is matched by an exact set of social security number(s) to the most recent mortgage, originated up to seven years before. The change in income from the prior mortgage is calculated, and annualized if the previous mortgage is more than one year old. Categorized variables are created based on the income change percentage, and if the prior mortgage was originated within the previous three months. The higher the income change, the more likely is income misrepresentation; particularly if the prior mortgage was originated within the months of the subject mortgage.

A ‘streamlined refinance’ independent variable may be when mortgages that were refinanced through streamlined programs have reduced income documentation. This lessens the incentive to misrepresent income, as well as the ability to dispute it in a review. Unlike low doc programs, these programs continue. RefiPlus-DU and RefiPlus-manual are separate variables from the variable for all other streamlined refinance mortgages.

A ‘verbal verification of employment’ independent variable may be when a binary variable that identifies when a DU requires a verbal verification of employment (VOE), and which is associated with a slightly higher incidence of income misrepresentation.

A ‘DU income change’ independent variable may be based on a comparison of the lowest income input with the last income input into DU to identifies if it is associated with a better recommendation or a DTI that drops below 45 in a final submission. The search through DU income data is both within the final submission, and across submissions that are on the same borrowers, property, and within 90 days of each other. When higher income did create a favorable DU recommendation, the percent change in income is categorized into variables. Higher percentage increases in income are correlated with income misrepresentation.

An ‘employer size’ independent variable may be when the DU employer names are standardized through a long list of model heuristics 119 that clean the data. A count is made of the number of times any applicant is observed on a DU delivery since a predetermined year, by the employer name. Categorical regressors are created based on the number of applicants that have been observed with each employer. The larger the employer, the lower the income misrepresentation rate. Presumably this is because larger employers are more likely to have contacts and verification procedures that are known to underwriters.

An ‘employer type’ independent variable may be when a search is made on the DU employer name for various types of employers, some of which have lower income misrepresentation rates. These flags are calculated on a borrower level and then aggregated to a loan level, so that a two-borrower loan may have two of these binary variables selected. Examples of employer type may include not working, state and local government, military, federal, education, healthcare. Not working employer names may include ‘not working,’ ‘retired,’ ‘housewife,’ ‘disability,’ etc. and may be associated with significantly lower income misrepresentation rates. State & Local Government employer names may include ‘city of,’ ‘state of,’ ‘county,’ ‘police,’ ‘fire,’ etc. and may be associated with lower income misrepresentation rates. Military employer names may include ‘USMC,’ ‘US Army,’ ‘US Navy,’ etc. and may be associated with lower income misrepresentation rates. Federal employer names may include words for federal government agencies such as ‘FBI,’ ‘IRS,’ ‘TSA,’ etc. and may be associated with slightly lower income misrepresentation rates. Education employer names may include ‘ISD,’ ‘school, ‘university of,’ etc. and may be associated with slightly lower income misrepresentation rates. Healthcare employer names may include ‘hospital,’ ‘medical,’ ‘clinic,’ etc. and may be associated with slightly lower income misrepresentation rates.

A ‘combined LTV’ independent variable may be a categorized variable, where higher LTV's have higher misrepresentation rates.

A ‘minimum FICO’ independent variable may be a categorized variable, where the highest FICO's have lower misrepresentation rates.

A ‘DTI’ independent variable may be a categorized variable, where the lower DTI's have lower misrepresentation rates.

An ‘occupancy’ independent variable may be a categorized variable, where investors have significantly higher misrepresentation rates, second homes also have higher misrepresentation rates.

A ‘Loan Amount’ independent variable may be a categorized origination amount, where higher loan amounts have higher misrepresentation rates.

A ‘15-year Fixed Rate’ independent variable may be a binary variable, where 15-yr fixed rate mortgages have significantly lower income misrepresentation rates.

A ‘One Borrower’ independent variable may be a binary variable, where one borrower mortgages have a higher misrepresentation rate than 2+ borrowers loans.

A ‘2-4 Unit’ independent variable may be a binary variable, where 2-4 unit properties have higher income misrepresentation rates.

A ‘DU Control’ independent variable may be when the source of data on income or employment details (beyond the sum of monthly income), is DU data. Since not all mortgages are underwritten through DU, any variable derived from DU data has either an implicit or explicit ‘not DU’ value. Because multiple variables are from DU data, it was decided to make these binary (aka ‘dummy’) variables rather than categorical (or class) variables, so that there would not be multiple variables that in essence said ‘not DU’ and would create unstable results. Instead there is a single DU binary flag that acts as a control variable for DU which measures a slightly higher income misrepresentation incidence for DU loans, though this is offsetting for some coefficients that are measured in DU.

Other independent variables may include Borrower income, loan purpose, borrower income, loan purpose, self-employment, ‘DU VOE & Paystub’ and ‘DU IRS Returns’ levels of documentation, income type, job title, and the like.

The dependent variables may be the income misrepresentation risks outputted by the model heuristics 119 based on common income misrepresentations. Dependent variables of the model heuristics 119 are loans with a significant finding, such as unacceptable income, unverified income, and misrepresentation of income. The TAU server 105a predicts the probability whether significant findings exists on loans. Additional significant findings may include DU income condition(s) not satisfied, all income documentation missing, and insufficient income. A single loan may have multiple significant findings, and one significant finding may lead to another. Therefore, significant findings are utilized to identify as their root cause the mistake, misrepresentation, or fraud of income. For example, missing documentation could be due to either poor underwriting or due to poor performance by the lender's document warehouse, which may in turn trigger significant findings of both missing income documents and insufficient income.

To identify dependent variable, the host application 110a may for an acquisition period parse a sampling of repurchase and/or indemnification letters to ascertain common income misrepresentation. That is, income misrepresentations are rarely as obvious as a janitor reporting an income of $200,000, and thus the host application 110a may look for other common clues. For instance, borrowers that inflate their income typically also inflated their job title, and even misrepresent their employer. Borrowers, who misrepresent their employer, often chose small firms, for which it may be easier to misrepresent employment.

Further, the model heuristic fit statistic for a binary logistic regression is a coefficient, which measures how close to optimal the model ranks the highest risk loans. For example, the model heuristics 119 may assign all the ‘bad’ loans with the highest probabilities of becoming bad within the population, a coefficient of 1.0. This is compared to a random prediction where there is no correlation between the prediction and the bad result, producing a coefficient of 0.0.

For income misrepresentations, the model heuristic coefficient may be 0.38. Note that coefficient statistics may not apply when comparing predictive abilities across different populations because the homogeneity of a population may likely lower a coefficient. For example, it is easier to predict the best basketball players among the general population, but it would be much harder to predict in a population of young, tall, men.

The model heuristics 119 may also output a message for why the loan is considered to have a higher risk of income misrepresentation. This message may be dictated by looking for the presence of high risk variables: income jump from prior mortgage, previous mortgage originated in prior 3 months, income jump in DU submission, employer name rarely observed, verbal verification of employment, layered risk of loan attributes, and the like.

Below is an example summary of the income misrepresentation rates and volumes by the model predicted probability of income defect (See Table 3). The model predicted misrepresentation rates closely correspond to the actual income misrepresentation rates that are observed for the in-sample population of all review types, so in aggregate the model is accurate, even if it does not rank order misrepresentation risk with great acuity.

Columns on the right side of the table are for the Random Post Purchase Reviews (RPPR), which may be more indicative of observed defect rates in the future when the sample is not biased by defect rich delinquency and foreclosure reviews. The observed income defect rates on the RPPR sample may be about half the level that was predicted by the model heuristics 119. This may suggest that the model heuristics 119 may still rank order income misrepresentation risk, but may tend to over-predict the defect rate. On the other hand, what constitutes a ‘significant’ finding may become more stringent, so that misrepresentation rates are higher on future post purchase reviews.

TABLE 3
Income Misrep Rates by Model Predicted Probability

| | All Review Types | | | | | Random Post Purchase Only | | | | |
|---|---|---|---|---|---|---|---|---|---|---|
| Predicted | | | | % All | % All | | | | % All | % All |
| Probability | # Rws | # Misrep | % Misrep | Rvws | Misrep | # Rws | # Misrep | % Misrep | Rvws | Misrep |
| <1% | 27,622 | 164 | 0.6% | 10.4% | 1.4% | 17,366 | 97 | 0.6% | 29.7% | 21.4% |
| 1% | 34,365 | 453 | 1.3% | 23.4% | 5.4% | 16,991 | 100 | 0.6% | 58.9% | 43.4% |
| 2% | 35,107 | 837 | 2.4% | 36.6% | 12.7% | 10,413 | 88 | 0.8% | 76.7% | 62.8% |
| 3% | 37,190 | 1,392 | 3.7% | 50.6% | 24.9% | 6,119 | 62 | 1.0% | 87.2% | 76.4% |
| 4% | 35,691 | 1,608 | 4.5% | 64.1% | 38.9% | 3,479 | 32 | 0.9% | 93.1% | 83.5% |
| 5% | 30,124 | 1,671 | 5.5% | 75.5% | 53.5% | 1,832 | 28 | 1.5% | 96.3% | 89.6% |
| 6% | 23,181 | 1,521 | 6.6% | 84.2% | 66.8% | 1,026 | 21 | 2.0% | 98.0% | 94.3% |
| 7% | 15,594 | 1,192 | 7.6% | 90.1% | 77.2% | 498 | 8 | 1.6% | 98.9% | 96.0% |
| 8% | 9,597 | 806 | 8.4% | 93.7% | 84.2% | 275 | 4 | 1.5% | 99.4% | 96.9% |
| 9% | 6,296 | 615 | 9.8% | 96.1% | 89.6% | 147 | 7 | 4.8% | 99.6% | 98.5% |
| 10% | 3,988 | 423 | 10.6% | 97.6% | 93.3% | 103 | 4 | 3.9% | 99.8% | 99.3% |
| 11% | 2,280 | 262 | 11.5% | 98.5% | 95.6% | 53 | 2 | 3.8% | 99.9% | 99.8% |
| 12% | 1,450 | 173 | 11.9% | 99.0% | 97.1% | 30 | 0 | 0.0% | 99.9% | 99.8% |
| 13% | 896 | 100 | 11.2% | 99.3% | 98.0% | 12 | 0 | 0.0% | 99.9% | 99.8% |
| 14% | 642 | 51 | 7.9% | 99.6% | 98.4% | 8 | 0 | 0.0% | 100.0% | 99.8% |
| 15% | 349 | 49 | 14.0% | 99.7% | 98.9% | 7 | 1 | 14.3% | 100.0% | 100.0% |
| 16% | 228 | 35 | 15.4% | 99.8% | 99.2% | 6 | 0 | 0.0% | 100.0% | 100.0% |
| 17% | 160 | 33 | 20.6% | 99.9% | 99.4% | 5 | 0 | 0.0% | 100.0% | 100.0% |
| 18% | 130 | 19 | 14.6% | 99.9% | 99.6% | 2 | 0 | 0.0% | 100.0% | 100.0% |
| 19% | 83 | 12 | 14.5% | 99.9% | 99.7% | 1 | 0 | 0.0% | 100.0% | 100.0% |
| 20% | 46 | 10 | 21.7% | 100.0% | 99.8% | 1 | 0 | 0.0% | 100.0% | 100.0% |
| >=21% | 124 | 22 | 17.7% | 100.0% | 100.0% | 1 | 0 | 0.0% | 100.0% | 100.0% |

Regarding asset defects, as indicated above, the model heuristics 119 may be utilized by the TAU server 105a to estimate asset misrepresentation risks by setting parameters and utilize independent variables to test the probability of dependent variables.

The independent variables for asset misrepresentation may be the received or acquired securitized data and data of the delivered loans. Examples of independent variables may include deposit non-borrower flag, deposit non-borrower 10 ks, months of reserves, streamlined refinance, combined LTV interacted with purpose, minimum FICO, DTI, occupancy, loan amount, 15-year fixed rate, one borrower, 2-4 unit, DU control, and the like.

A ‘deposit non-borrower flag’ independent variable may be a binary flag for DU asset deposits denoting over $100 in the balance of any of the following asset deposit types: gift not deposited, secured borrowed funds not deposited, and bridge loan not deposited. Loans with non-borrower assets have significantly higher asset misrepresentation rates.

A ‘deposit Non-borrower 10 ks’ independent variable may be a continuous value that is the sum of the dollar amount of gift, borrowed, and bridge loan deposit assets that exceed $100. For coefficient scaling, the dollar amount is divided by 10,000. Higher amounts of non-borrower funds have higher misrepresentation rates.

A ‘months of reserves’ independent variable may be a categorized variable, available from DU and as defined in the DU scorecard. Low reserves have higher misrepresentation rates.

A ‘combined LTV interacted with purpose’ independent variable may include categories for purchase, refinances, and cash-outs separately. Purchases and higher LTV's have higher misrepresentation rates, but misrepresentation varies less by LTV for purchase loans. Without this interaction, CLTV was not monotonic.

Other independent variables may include third party origination, loan amount and the like.

The dependent variables may be the asset misrepresentation risks outputted by the model heuristics 119 based on common asset misrepresentations. Dependent variables of the model heuristics 119 are loans with a significant finding, such as unacceptable source of funds, unsubstantiated source of funds, insufficient reserves, unverified assets, insufficient assets, misrepresentation of assets. The TAU server 105a predicts the probability whether significant findings exists on loans. Additional significant findings may include DU/AUS asset condition(s) not satisfied, and all asset documentation missing. A single loan may have multiple significant findings, and one significant finding may lead to another. Therefore, significant findings are utilized to identify as their root cause the mistake, misrepresentation, or fraud of income. For example, missing documentation could be due to either poor underwriting or due to poor performance by the lender's document warehouse, which may in turn trigger significant findings of both missing income documents and insufficient income.

For asset misrepresentations, the model heuristic coefficient may be 0.46. The model heuristics 119 may also output a message for why the loan is considered to have a higher risk of asset misrepresentation. This message may be dictated by looking for the presence of high risk variables: gift or borrowed funds, zero months reserves, FICO<620, or layered

Below is an example summary of the asset misrepresentation rates and volumes by the model predicted probability of asset defect (See Table 4). The model predicted misrepresentation rates closely correspond to the actual asset misrepresentation rates that are observed for the in-sample population of all review types, showing that in aggregate the model is accurate.

Columns on the right side of the table are for the Random Post Purchase Reviews (RPPR), which may be more indicative of observed defect rates in the future when the sample is not biased by defect rich delinquency and foreclosure reviews. The observed asset defect rates on the RPPR sample may be lower than was predicted by the model heuristics 119. This may suggest that the model heuristics 119 may still rank order asset misrepresentation risk, but may tend to over-predict the defect rate. On the other hand, what constitutes a ‘significant’ finding may become more stringent, so that misrepresentation rates are higher on future post purchase reviews.

TABLE 4
Asset Misrep Rates by Model Predicted Probability

| | All Review Types | | | | | Random Post Purchase Only | | | | |
|---|---|---|---|---|---|---|---|---|---|---|
| Predicted | | | | % All | % All | | | | % All | % All |
| Probability | # Rws | # Misrep | % Misrep | Rvws | Misrep | # Rws | # Misrep | % Misrep | Rvws | Misrep |
| <1% | 63,921 | 364 | 0.6% | 21.7% | 4.4% | 25,323 | 107 | 0.4% | 43.2% | 18.0% |
| 1% | 77,744 | 1,092 | 1.4% | 48.2% | 17.7% | 16,413 | 125 | 0.8% | 71.2% | 39.1% |
| 2% | 54,156 | 1,318 | 2.4% | 66.6% | 33.7% | 9,384 | 137 | 1.5% | 87.2% | 62.1% |
| 3% | 31,775 | 1,127 | 3.5% | 77.4% | 47.4% | 3,636 | 100 | 2.8% | 93.4% | 79.0% |
| 4% | 23,009 | 1,093 | 4.8% | 85.2% | 60.7% | 1,686 | 42 | 2.5% | 96.3% | 86.0% |
| 5% | 16,201 | 928 | 5.7% | 90.7% | 72.0% | 980 | 36 | 3.7% | 98.0% | 92.1% |
| 6% | 8,922 | 630 | 7.1% | 93.7% | 79.7% | 518 | 11 | 2.1% | 98.8% | 93.9% |
| 7% | 6,612 | 488 | 7.4% | 96.0% | 85.6% | 274 | 15 | 5.5% | 99.3% | 96.5% |
| 8% | 3,757 | 296 | 7.9% | 97.3% | 89.2% | 140 | 5 | 3.6% | 99.6% | 97.3% |
| 9% | 2,585 | 262 | 10.1% | 98.1% | 92.4% | 115 | 7 | 6.1% | 99.7% | 98.5% |
| 10% | 1,057 | 95 | 9.0% | 98.5% | 93.5% | 51 | 2 | 3.9% | 99.8% | 98.8% |
| 11% | 1,532 | 155 | 10.1% | 99.0% | 95.4% | 43 | 3 | 7.0% | 99.9% | 99.3% |
| 12% | 892 | 99 | 11.1% | 99.3% | 96.6% | 20 | 2 | 10.0% | 99.9% | 99.7% |
| 13% | 530 | 59 | 11.1% | 99.5% | 97.3% | 8 | 0 | 0.0% | 100.0% | 99.7% |
| 14% | 733 | 93 | 12.7% | 99.7% | 98.5% | 8 | 2 | 25.0% | 100.0% | 100.0% |
| 15% | 377 | 57 | 15.1% | 99.9% | 99.2% | 7 | 0 | 0.0% | 100.0% | 100.0% |
| 16% | 107 | 13 | 12.1% | 99.9% | 99.3% | 4 | 0 | 0.0% | 100.0% | 100.0% |
| 17% | 156 | 32 | 20.5% | 100.0% | 99.7% | 1 | 0 | 0.0% | 100.0% | 100.0% |
| 18% | 44 | 9 | 20.5% | 100.0% | 99.8% | 1 | 0 | 0.0% | 100.0% | 100.0% |
| 19% | 22 | 8 | 36.4% | 100.0% | 99.9% | 1 | 0 | 0.0% | 100.0% | 100.0% |
| 20% | 12 | 3 | 25.0% | 100.0% | 100.0% | 0 | 0 | 0.0% | 100.0% | 100.0% |
| >=21% | 26 | 3 | 11.5% | 100.0% | 100.0% | 3 | 0 | 0.0% | 100.0% | 100.0% |

In addition, the model heuristics 119 may be run for a predetermined period (e.g., several months) and its output used for reviewing mortgages. The actual observed income and asset misrepresentation rates may be compared to the model heuristics 119 predicted volumes, and the model heuristics 119 predictions may be calibrated by a residual factor.

After the completion of the regression and the coefficients are estimated, the TAU server 105a outputs 450 a risk evaluation based on the coefficients. That is, once the TAU server 105a has detected property transaction defects and calculated the likelihood of misrepresentation for those detected property transaction defects, the decision support system 300 may present the defects through user interfaces to support end user decisions in a risk evaluation summary for subsequent review in support of end user decisions (e.g., aggregate heuristic level confidence metrics into risk variable level metrics, which are further aggregated into loan level confidence metrics). The risk evaluation summary may include a view of comparisons made by the host application 110a via flags that identify data fields of the delivered loan. Returning to FIG. 4C, the excerpt of an exemplary loan summary screen 440a illustrates the risk evolution 446, which states that the case file is ineligible due to the excess total expense ratio in combination with other risk factors.

FIG. 5 illustrates a process flow 500 utilized by the TAU server 105a to determine if a borrower would have qualified for a loan as the transaction should have been submitted, rather than as represented.

The process flow 500 begins by receiving 510 a plurality of sequential underwriting submissions. That is, multiple sequential underwriting submissions that pertain to the same transaction may be submitted by an end user at one of the computing systems 105a-b. The number of sequential submission may be at least two submissions within a designated time period. The designated time period is any amount of time predefined by the host application 111a. The designated time period may be for example within minutes, days, weeks, or months.

If the at least two submission are received within the designated time period, the process flow proceeds by comparing 520 corresponding data fields of each submission to identify the existence of inconsistent information. Examples of the data fields that may be manipulated include occupancy status, income, credit score with respect to a borrower income, residency, debts, assets, and the like. By comparing the corresponding data fields of each submission the TAU server 105a may observe or detect data changes (e.g., disparate information between underwriting submissions) in the automated underwriting systems. The TAU server 105a may further cross-reference secondary data (e.g., credit reports or appraisal data) with the data fields of each submission to further identify inconsistencies.

FIG. 5B illustrates an example of observing data changes via a DU data screen 540a of the single use portal. The DU data screen 540a illustrates five underwriting submission, each of which have an entry under the submission date block 542, the loan amount block 544, and the income block 546. As shown the submission date block 542, the submission dates for each underwriting submission may be grouped under September and April. For the April underwriting submission, there are three variations of income, as shown in the income block 546. However, the loan amount did not vary as a result of the income variation. Thus, although inconsistent information was identified, this inconsistent information may have a low probability of misrepresentation.

Next, the process flow 500 may generate 530 a significance test based on the data fields that historically contain the inconsistent information. For instance, the TAU server 105a may access historical data stored in one of the database 120a-b and identify which data field is continuously being manipulated. The TAU server 105a may then automatically scrutinize the data field of the underwriting submission to enhance the detection of the inconsistent information.

The TAU server 105a continues by utilizing 540 the significance test to analyze the submissions in view of an approval status or loan value of each submission and determining 550 whether the submission are indicative of system manipulation based on the significance test. That is, the simulation module 118 of TAU server 105a may be configured to flag the property transaction related to the data changes as characteristic of a higher credit risk than stated and possibly fraud (e.g., flag the property transaction and identify a risk level).

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description or Abstract below, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A method for evaluating risk in an acquisition in support of end user decisions, the method comprising:
accessing, by a processing unit, at least one database to retrieve documentation corresponding to the acquisition and secondary information corresponding to the documentation, the documentation and secondary information each including data fields;
comparing the documentation data fields with corresponding secondary information data fields to identify acquisition defects;
applying risk heuristics on the acquisition defects to generate a probability estimation for each acquisition defect; and
outputting a risk evaluation for the acquisition including a confidence metric based on an aggregation of the probability estimations.

2. The method of claim 1, further comprising:
designating a lag period in which evaluation of the acquisition is delayed, the lag period being an amount of time between delivery of the acquisition and delivery of secondary information available for the acquisition.

3. The method of claim 1, wherein applying risk heuristics on the acquisition defects includes:
correlating variables to the documentation data fields,
generating coefficients for each variable, and
generating the probability estimations based on the coefficients.

4. The method of claim 3, wherein the variables include at least one of statistical significance, business significance, reasonableness, and substitutes.

5. The method of claim 1, wherein applying risk heuristics on the acquisition defects includes:
analyzing a credit history of a borrower identified in the acquisition by individual lines of credit to identify differences in the credit history.

6. The method of claim 1, wherein probability estimations indicate a likelihood that each acquisition defect identified by the comparison between the documentation data fields and corresponding secondary information data fields are misrepresentations.

7. A computer-readable medium tangibly embodying computer-executable instructions for evaluating risk in an acquisition in support of end user decisions, comprising:
accessing, by a processing unit, at least one database to retrieve documentation corresponding to the acquisition and secondary information corresponding to the documentation, the documentation and secondary information each including data fields;
comparing the documentation data fields with corresponding secondary information data fields to identify acquisition defects;
applying risk heuristics on the acquisition defects to generate a probability estimation for each acquisition defect; and
outputting a risk evaluation for the acquisition including a confidence metric based on an aggregation of the probability estimations.

8. The computer-readable medium of claim 7, further comprising:
designating a lag period in which evaluation of the acquisition is delayed, the lag period being an amount of time between delivery of the acquisition and delivery of secondary information available for the acquisition.

9. The computer-readable medium of claim 7, wherein applying risk heuristics on the acquisition defects includes:
correlating variables to the documentation data fields,
generating coefficients for each variable, and
generating the probability estimations based on the coefficients.

10. The computer-readable medium of claim 9, wherein the variables include at least one of statistical significance, business significance, reasonableness, and substitutes.

11. The computer-readable medium of claim 7, wherein applying risk heuristics on the acquisition defects includes:
analyzing a credit history of a borrower identified in the acquisition by individual lines of credit to identify differences in the credit history.

12. The computer-readable medium of claim 7, wherein probability estimations indicate a likelihood that each acquisition defect identified by the comparison between the documentation data fields and corresponding secondary information data fields are misrepresentations.

13. A system, comprising:
a device including a memory with an application configured to evaluate risk in an acquisition to support end user decisions installed thereon, wherein the application is configured to:
access at least one database to retrieve documentation corresponding to the acquisition and secondary information corresponding to the documentation, the documentation and secondary information each including data fields;
compare the documentation data fields with corresponding secondary information data fields to identify acquisition defects;
apply risk heuristics on the acquisition defects to generate a probability estimation for each acquisition defect; and
output a risk evaluation for the acquisition including a confidence metric based on an aggregation of the probability estimations.

14. The system of claim 13, wherein the application is configured to:
designate a lag period in which evaluation of the acquisition is delayed, the lag period being configured based on an amount of time between delivery of the acquisition and delivery of secondary information available for the acquisition.

15. The system of claim 13, wherein the application applies the risk heuristics on the acquisition defects by being configured to:
correlate variables to the documentation data fields,
generate coefficients for each variable, and
generate the probability estimations based on the coefficients.

16. The system of claim 13, wherein the variables include at least one of statistical significance, business significance, reasonableness, and substitutes.

17. The system of claim 13, wherein the application applies the risk heuristics on the acquisition defects by being configured to:
analyze a credit history of a borrower identified in the acquisition by individual lines of credit to identify differences in the credit history.

18. The system of claim 13, wherein probability estimations are configured to indicate a likelihood that each acquisition defect identified by the comparison between the documentation data fields and corresponding secondary information data fields are misrepresentations.
